(19) United States
(12) Patent Application Publication
(10) Pub. No.: US 2020/0380054 A1
(43) Pub. Date: Dec. 3, 2020

(54) METHOD AND SYSTEM FOR SEARCH AND NOTIFICATION

(71) Applicant: Sprockety Ventures Inc., Saskatchewan (CA)

(72) Inventor: Tod Raymond Baudais, Saskatchewan (CA)

(73) Assignee: Sprockety Ventures Inc., Saskatchewan (CA)

(21) Appl. No.: 16/958,402

(22) PCT Filed: Nov. 16, 2018
(86) PCT No.: PCT/CA2018/051460

§ 371 Date: Jun. 26, 2020

Related U.S. Application Data
(60) Provisional application No. 62/611,807, filed on Dec. 29, 2017.

(51) Int. Cl. G06F 16/9535; G06F 40/205; G06F 16/9538

(52) U.S. Cl. CPC G06F 16/9535; G06F 40/30; G06F 16/9538; G06F 40/205

(57) ABSTRACT

A search engine that performs a periodic query to inform users of when the query criteria are met. A server for performing a computer-based search having a processor in communication with a transceiver. The processor executing instructions from a computer-readable medium. The transceiver receiving a request for a web page from a client and generating the web page and providing the web page to the client. The transceiver receiving a search request string and a client identifier. The search request string is parsed and separated into a search term, a user specific string, and a search context string. The search context string is compared to one or more supported query strings. The transceiver transmitting a closest matching supported query string to the client for a confirmation.

### FIELD OF THE INVENTION

This invention is in the field of search engines, and more specifically to a search engine that performs a periodic query to inform users of when the query criteria are met.

### BACKGROUND

Some prior search and retrieval systems and methods involve a user manually setting up an alert. For example, Google Alerts (https://www.google.ca/alerts) sends email to a user when the search engine finds new results, such as web pages, newspaper articles, blogs, or scientific research, that match the user's search term(s).

Other web sites have email alerts, such as job alerts, utility company alerts, weather alerts, news alerts, shopping alerts, investor alerts, government alerts, organization alerts, publication alerts, financial alerts, and network alerts. These types of alerts, although useful, are restricted to the topic area of the host website and cannot be combined with alerts from other websites.

One web-based service called “if this then that” IFTTT (https://ifttt.com) provides users with more sophisticated chains of simple conditional statements, called applets. An applet is triggered by changes that occur within other web services such as Gmail, Facebook, Instagram, or Pinterest. For example, an applet may send an e-mail message if the user tweets using a hashtag, or copy a photo on Facebook to a user's archive if someone tags a user in a photo. IFTTT uses a drag and drop graphical interface to configure their queries, as opposed to using plain English for queries.

More sophisticated personal assistants have been developed. For example, Google Now uses a natural language user interface to answer questions, make recommendations, and perform actions by delegating requests to a set of web services. Along with answering user-initiated queries, Google Now proactively delivers information to users that it predicts (based on their search habits) they may want. Google Now, of course, focuses on what is happening at the moment in time that the search is performed (i.e. now).

Some systems, such as Amazon Alexa, Microsoft Cortana, or Apple Siri, are capable of voice recognition, music playback, making to-do lists, setting alarms or reminders, answering basic questions, streaming podcasts, playing audiobooks, and providing weather, traffic, and other real time information, such as news. Besides calendar functionality, these systems focus on the present time—i.e., submit a query, get an immediate response.

Some of these intelligent agents have been implemented on a smart speaker system, such as Google Home or Amazon Echo, that enables users to speak voice commands to interact with services. A large number of services, both in-house and third-party, are integrated, allowing users to listen to music, look at videos or photos, or receive news updates entirely by voice. Some systems also enable home automation features, letting users speak commands to the device to control smart home appliances. Some systems also provide proactive updates ahead of scheduled events, visual responses on mobile devices or Chromecast-enabled televisions, Bluetooth music streaming, and the ability to schedule calendar appointments, with upcoming support for reminders. Again, other than calendar functionality, these systems focus on the present time—i.e., voice a query, get an immediate response.

### SUMMARY OF THE INVENTION

According to an aspect described herein, there is provided a server processing structure for performing a computer-based search. The server processing structure may comprise: at least one processor in communication with a transceiver. At least one processor may execute instructions from a computer-readable medium. The instructions may comprise at least one of: receiving, from the transceiver, a request for a web page from a client processing structure; generating the web page and providing the web page to the client processing structure; receiving, from the transceiver, a search request string and a client identifier; parsing the search request string and separating the search request string into one or more search terms, a client identifier, and a search context string; comparing the search context string to a plurality of supported query strings; and transmitting, by the transceiver, a closest matching supported query string to the client processing structure for a confirmation.

The instructions may further comprise receiving the confirmation and adding one or more search terms, the client identifier, and the search context string to a periodic search query database. The instructions may further comprise retrieving at least one periodic search query from the periodic search query database and executing at least one periodic search query to retrieve at least one result. The instructions may further comprise scraping data from at least one external web site into a sources database. At least one periodic search query may be compared to a plurality of entries in the sources database. When at least one periodic search query satisfies a matched entry from the plurality of entries, transmitted by the transceiver, a notification may be sent to the client processing structure associated with the client identifier corresponding to the search request string. The notification may comprise the matched entry. The notification may be selected from the following, but not limited to: an in-app notification, a text message, an email, and a social media notification. At least one periodic search query may be compared according to a period.

According to another aspect described herein, there is provided a method for performing a computer-based search comprising of at least one of: receiving, from a transceiver, a request for a web page from a client processing structure; generating the web page and providing the web page to the client processing structure; receiving, from the transceiver, a search request string and a client identifier; parsing the search request string into one or more search terms, the client identifier, and the search context string; comparing the search context string to a plurality of supported query strings; and transmitting, by the transceiver, a closest matching supported query string to the client processing structure for a confirmation.

The method may further comprise receiving the confirmation and adding the search request string along with the client identifier to a periodic search query database. The method may further comprise retrieving at least one periodic search query from the periodic search query database and executing at least one periodic search query to retrieve zero or more results. The method may further comprise scraping data from at least one external web site into a sources database. The method may further comprise comparing at least one periodic search query to a plurality of entries in the sources database. When at least one periodic search query satisfies a matched entry from the plurality of entries, transmitted by the transceiver, a notification is sent to the client processing structure associated with the client identifier corresponding to the search request string. The notification may comprise the matched entry. The notification may be selected from the following, but not limited to: an in-app notification, a text message, an email, and a social media notification. At least one periodic search query may be compared according to a period.

Other aspects may be apparent to one of skill in the art upon review of the description and drawings herein.

### DESCRIPTION OF THE DRAWINGS

While the invention is claimed in the concluding portions hereof, example embodiments are provided in the accompanying detailed description which may be best understood in conjunction with the accompanying diagrams where like parts in each of the several diagrams are labeled with like numbers, and where:

FIG. 1 is a block diagram of a client processing structure and a server processing structure; and

FIG. 2 is a flow chart of a search and notification process executing on the client processing structure and the server processing structure.

### DETAILED DESCRIPTION OF THE ILLUSTRATED EMBODIMENTS

Conventional search and retrieval systems are limited to making queries and retrieving a response (e.g., results) immediately. These conventional systems have no concept of a query that is to be executed in the future in order to retrieve results that satisfy the search query. Some of these systems have scheduling functionality where a user may request notification (e.g., “wake me in 4 hours”), but these prior systems are incapable of alerting a user when a search event is satisfied (e.g., “alert me when Taylor Swift announces a new tour”). According to one or more aspects described herein, the system and/or method may provide future-based queries that may be triggered when the event happens rather than returning the results immediately. Some websites have website-specific alerts, such as weather warnings or notifications that happen when a weather update is made available. These website-specific alerts do not allow for users to enter queries in plain English nor do they allow for gathering information from multiple different sites to satisfy a query.

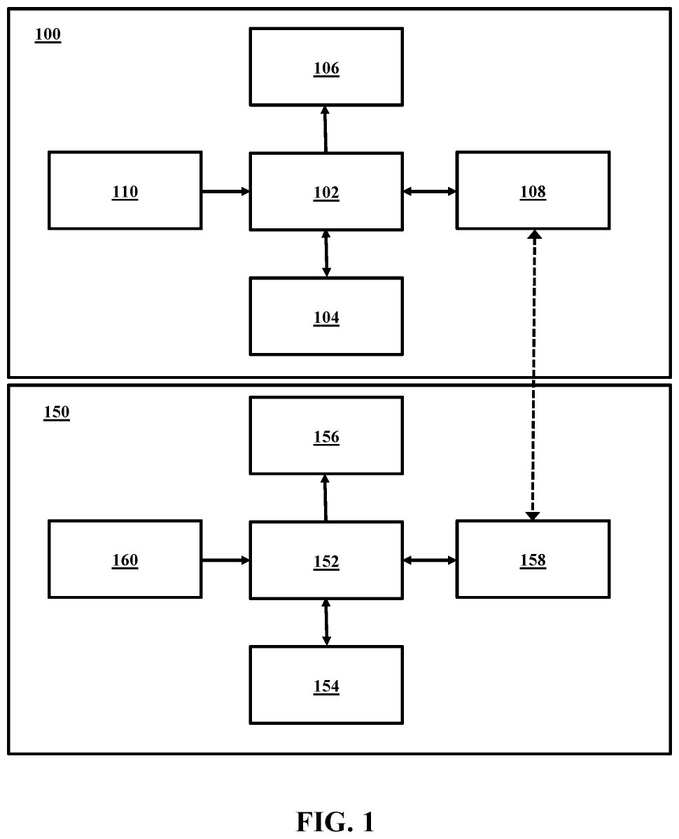

With reference to FIG. 1, a client processing structure 100 may be in communication with a server processing structure 150. The client processing structure 100 may comprise at least one processor 102 executing instructions from a computer-readable medium 104 (e.g., RAM or ROM memory, a hard drive, flash drive, etc.) that transform the client processing structure 100. The at least one processor 102 may receive user input from a user interface 110 (e.g., keyboard, keypad, virtual keyboard, touch screen, mouse, joystick, microphone, etc.). The at least one processor 102 may display data to the user on a display 106. The at least one processor 102 may electronically communicate with the server processing structure 150 using a transceiver 108 (e.g., WiFi, Bluetooth, 3G, Ethernet, or other communication protocol). The transceiver 108 may communicate over the Internet.

Similarly, the server processing structure 100 may comprise at least one processor 152 executing instructions from a computer-readable medium 104. The at least one processor 152 may receive operator input from an operator interface 110. The at least one processor 152 may display data to the operator on a display 156. The at least one processor 152 may electronically communicate with the client processing structure 100 using a transceiver 158.

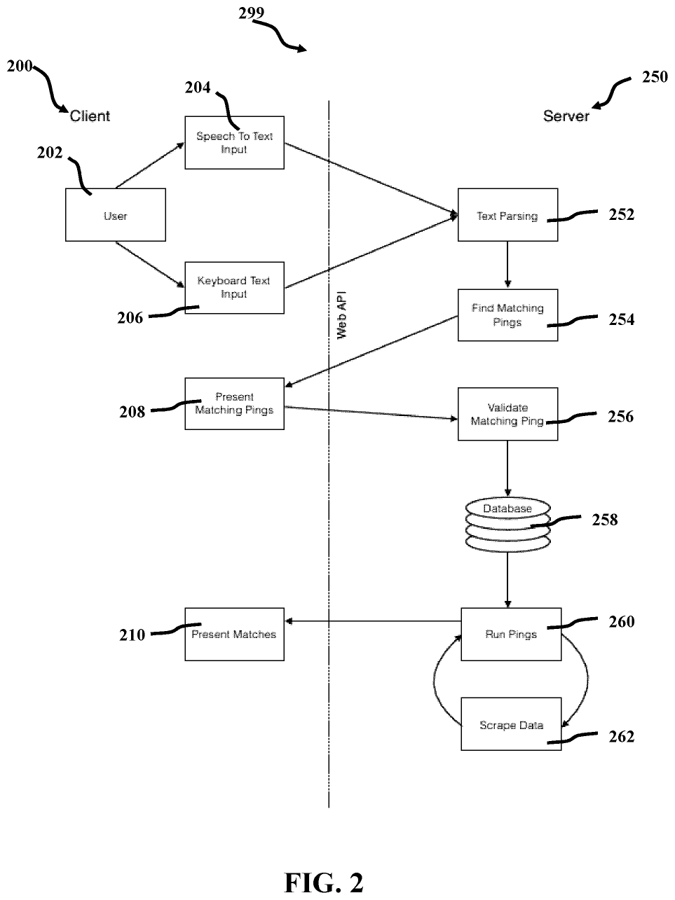

With reference to FIG. 2, a search and notification process 299 executing on the client processing structure 100 and the server processing structure 150 is presented. The search and notification process 299 may be divided into client process tasks 200 and server process tasks 250. The client process tasks 200 may be executed on the client processing structure 100 whereas the server processing structure 250 may be executed on the server processing structure 150.

The search and notification process 299 begins when a user 202 provides input to the user interface 110. If the user provides a textual input on a textual interface, such as a keyboard, then the client processor 102 may receive the textual input and process the textual input into a packet (e.g., a search request) for transmission using the transceiver 108. If the user provides a speech input via the microphone, then the client processor 102 may execute a speech-to-text process 204 in order to convert an audio signal into the textual input. Likewise, the textual input may be packaged into the search request specified by the server web API. In one aspect, the interactions between the client processing structure 100 and the server processing structure 150 may be performed using JavaScript Object Notation (JSON). The initial query from the client processor 102 may be a JSON data packet containing an English query that is sent to the server processing structure 150 for processing. For example, the initial query may be:

/api/v1/main/submit
Query:
{

“query”: ″Ping me when Star Wars is in movie theatres”

}
Response:
{

“queries” : {

...summary information for each of the matching queries including placeholder

matches and data needed to present the confirmation...

}

}

Once the confirmation has been accepted, an agent may be added by:

/api/v1/main/addagent
Query:
{

“query_id”:”movie_in_theatres”,
“keywords”: {

“movie”: “Star Wars″

}

}
Response:
{

“error”:”Error message″

}

All interactions with the web server are done with JSON.

In some aspects, the speech-to-text process 204 may comprise Siri, Alexa, Echo, other voice-based systems, and/or a combination thereof.

In some aspects, the client processor 102 may submit a request for a web page from the server processing structure 150 via the transceiver 108. The server processing structure 150, upon receipt of the web page request, may retrieve or generate the web page and provide the web page to the client processing structure 100. The web page may comprise one or more graphical user interfaces for receiving input from the user using the user interface 110. The user may then submit the user input using the web page to the server processing structure 150.

Once the server processing structure 150 receives the search request via the transceiver 158, the one or more processors 152 may perform a text parsing process 252 on the textual input. The text parsing process 252 may comprise a semantic analysis and/or pattern matching on the textual input in order to determine a search context. The text parsing process may also involve a machine learning process. The search context may be particular to a future search query. For example, the user may submit a query using plain English (e.g., natural language), such as asking to be notified when a particular event or happening occurs. Although the description herein refers to plain English, the techniques described may apply equally well to any informal (e.g., plain) or formal language.

The user query may be matched to the supported queries by looking for a closest match for a database of predetermined supported query strings. The supported queries may be specified in plain English with placeholders for the locations of the supported search terms. For example, one of the supported queries might look like: “Ping me when <movie> is in movie theatres.” The search query string may be separated into a command (e.g., “Ping me when”), one or more search terms (e.g., “<movie>”), and a search context string (e.g., “is in movie theatres”). In this aspect, the command may be discarded as it may be standard across all queries, although other aspects may change and provide additional types of commands. The search terms may provide the desired content for the search query. The search context string may be correlated to the supported queries to determine a matching score which determines “closeness” of the query string to the supported query string. The fixed text surrounding the placeholder text may be used as a search in the query text. Individual words may be compared using fuzzy logic matching algorithms to account for misspelling or other grammatical errors. Each supported query undergoes the same matching process. The greater the number and range of matches, the higher the score.

The actual text in the location of the placeholder text may be identified and added to the query. The query (or queries) with the highest match may be chosen and then presented back to the user on their client processing structure 100 for confirmation. Once the confirmation is received by the server processing structure, the processing structure stores the search into a query database.

When the search context has been determined, the one or more processors 152 may perform a matching process 254 in order to determine an appropriate query that may provide a search result relevant to the search context. As part of the matching process 254, a search query may be performed on the query database to determine a plurality of potential matches. The search query may be performed on an internal database, external data sources, and/or individual websites. At least a portion of the plurality of potential matches may then be provided to the client processing structure 100 over the transceiver 158.

The client processing structure 100 may then display the portion of the plurality of potential matches on the display 106 at step 208. The client processing structure 100 may also present one or more additional options to the user in order for the user to refine the appropriate query. For example, the user may provide a search query “Ping me when Star Wars is in movie theatres.” The client processing structure 100 may then determine that multiple Star Wars movies are coming to theatres and ask you which particular movie you are referring to. The one or more processors 102 may also provide a verification prompt in order to receive a confirmation from the user on the user interface 110. Once the user has provided the confirmation, the client processing structure 100 may provide the confirmation to the server processing structure 150 via the transceiver 108.

The server processing structure 150 may perform a validating process 256 where the appropriate query may be validated and formatted to be stored in a periodic query database 258 within the computer-readable medium 154.

The server processing structure 150 may execute a periodic query process 260 that executes one or more periodic search queries from a database according to their respective schedule. The periodic search queries may specify the search request string, a search frequency (or period), and a client identifier, which identifies the client processing structure 150 associated with the search request string. For example, some queries are not time sensitive and may run twice a day. For other more time sensitive queries, the server processing structure 150 may execute once a minute or, in other instances (such as news story queries), may execute once every 15 minutes. In another example, queries related to weather forecasts may be performed once a day. The periodic query process 260 may retrieve at least a portion of the periodic query database 258 from the computer-readable medium 154 and perform a search query.

When the periodic query process 260 identifies matches, a trigger may be initiated by the server processing structure 150, which provides a notification to the client processing structure 100 via the transceiver 108. In some aspects, the identification of matches may be text matching or may be a comparison of values and numbers (e.g., like snowfall amount to a threshold snowfall). The notification may be provided to the client processing structure 100 via, but not limited to: an in-app notification, a text message, an email, and/or a social media notification. For example, when the particular event or happening occurs, the server processing structure 150 may notify the user of this occurrence via, but not limited to: an in-app notification, a text message, an email, and a social media notification.

In some aspects, the server processing structure 150 may monitor one or more external web sites and scrape data (at step 262) into the sources database. In some aspects, the server processing structure 150 may download a webpage associated with each stored query. In other aspects, the server processing structure 150 may retrieve the scraped data using one or more APIs (such as, for example, the Facebook API). Each query type may be associated with a list of satisfactory data sources. The scraping process 262 may only monitor web sites specified by the supported queries or the periodic query database 258.

For example, the user may enter the request: “Ping me when it snows 50 cm or more in Panorama, B.C.” This action may then set up a query that checks the snowfall at the ski area daily and then notifies the user when it has or is expected to snow more than 50 cm at Panorama. In some aspects, the user may be required to indicate a frequency of the query. In other aspects, a default frequency may be determined based on the type of query. The frequency may be by the minute, hour, day, week, month, year, etc.

In some aspects, the client processing structure 100 may continuously monitor the user interface 110 for a particular phrase, such as “Ping me when” in order to initiate the search and notification process 299 as herein described.

In some aspects, the scraping process 262 may monitor multiple web sites to determine more complex information, such as the query “Ping me when it snows more than 100 cm in Fernie, B.C. and the highways are all clear.” In this example, the scraping process 262 may monitor the Weather Network website (or a different weather website) and the B.C. Highways web site.

According to the aspects described herein, the examples of the following queries may be performed by the search and notification process 299:
[name of product] goes on sale; and a follow up request of which stores to monitor (in other aspects, the stores may be retrieved from the database based on the product type;
[______] is in the news;
[ ] movie comes out;
[musical artist] releases a new song/album;
[musical artist] announces a new tour;
it's one week before my wedding anniversary; and a follow up request to the user for when the wedding anniversary is;
it's one week before my spouse's birthday; and a follow up request for when the spouse's birthday is;
this week's lottery numbers are announced;
the new iPhone is released;
the overnight temperature is forecast to be below [temperature];
the daytime high is forecast to be above [temperature];
the stock price of [name of company] reaches its 52-week high;
the stock price of [name of company] reaches a 52-week low;
the stock price of [name of company] rises above $______;
the stock price of [name of company] falls below $______;
the price of gas starts going up at certain stations (so that I can still get it cheaper at stations that have yet to elevate their price); and a follow up request for what location (or, alternatively, the GPS coordinates may be used);
any retail stores in ______ industry announce that they are “going out of business;”
any retail stores in ______ industry announce special promotions;
[name of friend] makes a new Facebook post;
any surveys or polls are released related to [topic];
[name of company] announces a new product;
[name of hockey player] scores a hat trick;
it's one week before [name of hockey team] is going to be in town to play the Oilers;
it's 30 days before tax filing deadline;
vacations to [name of place] are announced;
Maxmillions lottery jackpot is over $50M;
there's going to be an astronomical event happening (e.g., by monitoring particular astronomical websites that provide notable astronomical events, such as NASA);
PetSmart gets new puppies/kittens;
over 10 cm of snow is expected to fall overnight (e.g., by GPS or by requesting a location);
a condo unit comes for sale in building “X”;
any condo unit in [name of city/town] is reduced in price;
a seat sale is announced on [name of airline];
[name of airline] announces a seat sale to [particular destination];
skiing conditions at [name of resort] are excellent;
[Name of person] instagrams something;
Donald Trump discusses nuclear weapons (e.g., by searching one or more news websites);
Donald Trump mentions North Korea (e.g., by searching one or more news websites);
a new art exhibit is in town (e.g., by requesting which art exhibit and in which location);
someone launches a new recipe that involves zucchini (e.g., by searching either a user specified recipe site or selecting a pre-determined recipe site);
Oprah talks about Weight Watchers;
Mini Wheats go on sale at Safeway;
it's my parents' wedding anniversary; and a follow up request to the user for when the wedding anniversary is;
any crowdfunding campaigns start pertaining to ______ (e.g., the user may specify a particular crowdfunding website or pre-determined crowdfunding websites may be searched);
John Oliver talks about Donald Trump;
John Oliver talks about Vladimir Putin;
Will Ferrell is going to be a guest on any late night talk show;
[author] launches a new book;
a new book is launched pertaining to [subject area];
the Pulitzer Prize winners are announced;
the Nobel Prize winners are announced;
a new store opens in [name of city];
a new restaurant opens in [name of city];
a certain type of job is posted in [name of region];
a particular band or musical act is coming to [name of city/town];
a litter of [name of species] puppies is for sale within 50 km of your home; and/or
a person with [certain qualities] has posted their availability on [name of dating sites].

Although the aspects herein describe a transceiver 108, 158, other aspects may comprise a plurality of transceivers 108, 158 that may each have a different communication architecture.

Although the aspects described herein relate to a single client processing structure 100 working in conjunction with a single server processing structure 150, other aspects may have a plurality of client processing structures 100 working in conjunction with a single server processing structure 150. Other aspects may have a plurality of client processing structures 100 working in conjunction with a plurality of server processing structures 150. In some aspects, a single client processing structure 100 may work in conjunction with a plurality of server processing structures 150. A server processing architecture may comprise the plurality of server processing structures 100 that may distribute the processing load amongst themselves depending on a request from a plurality of client processing structures 100.

Although the aspects herein describe the periodic query process 260, periodic query process 260 may be performed at an interval of seconds, minutes, hours, days, weeks, months, years, and/or decades. In some cases, the particular period may be specified when the query is added to the database of supported queries.

According to some aspects, there may be provided a method of sharing the client queries with other users. According to some aspects, there may be provided a method of having sponsored results.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A server processing structure for performing a computer-based search comprising:
at least one processor in communication with a transceiver, the at least one processor executing instructions from a computer-readable medium, the instructions configured to perform:
receiving, from the transceiver, a request for a web page from a client processing structure;
generating the web page and providing the web page to the client processing structure;
receiving, from the transceiver, a search request string and a client identifier;
parsing the search request string and separating the search request string into a search term, a user specific string, and a search context string;
comparing the search context string to a plurality of supported query strings; and
transmitting, by the transceiver, a closest matching supported query string to the client processing structure for a confirmation.

2. The server processing structure according to claim 1, the instructions are further configured to receive the confirmation and add the parsed search request string along with the client identifier to a periodic search query database.

3. The server processing structure according to claim 2, the instructions are further configured to retrieve at least one periodic search query from the periodic search query database and execute the at least one periodic search query to retrieve zero or more results.

4. The server processing structure according to claim 3, the instructions are further configured to scrape data from at least one external web site into a sources database.

5. The server processing structure according to claim 4, wherein the at least one periodic search query is compared to a plurality of entries in the sources database.

6. The server processing structure according to claim 5, wherein when the at least one periodic search query satisfies a matched entry from the plurality of entries, transmitting, by the transceiver, a notification to the client processing structure associated with the client identifier corresponding to the search request string.

7. The server processing structure according to claim 6, wherein the notification comprises the matched entry.

8. The server processing structure according to claim 7, wherein the notification is selected from at least one of: an in-app notification, a text message, an email, and a social media notification.

9. The server processing structure according to claim 5, wherein the at least one periodic search query is performed according to a period.

10. The server processing structure according to claim 1, wherein the search request string is selected from natural language, formal language, and a combination thereof.

11. A method for performing a computer-based search comprising:
receiving, from a transceiver, a request for a web page from a client processing structure;
generating the web page and providing the web page to the client processing structure;
receiving, from the transceiver, a search request string and a client identifier;
parsing the search request string and separating the search request string into at least one search term, the client identifier, and a search context string;
comparing the search context string to a plurality of supported query strings; and
transmitting, by the transceiver, a closest matching supported query string to the client processing structure for a confirmation.

12. The method according to claim 11, further comprising receiving the confirmation and adding the search request string along with the client identifier to a periodic search query database.

13. The method according to claim 12, further comprising retrieving at least one periodic search query from the periodic search query database and executing the at least one periodic search query to retrieve zero or more results.

14. The method according to claim 13, further comprising scraping data from at least one external web site into a sources database.

15. The method according to claim 14, further comprising comparing the at least one periodic search query to a plurality of entries in the sources database.

16. The method according to claim 15, wherein when the at least one periodic search query satisfies a matched entry from the plurality of entries, transmitting, by the transceiver, a notification to the client processing structure associated with the client identifier corresponding to the search request string.

17. The method according to claim 16, wherein the notification comprises the matched entry.

18. The method according to claim 17, wherein the notification is selected from at least one of: an in-app notification, a text message, an email, and a social media notification.

19. The method according to claim 15, wherein the at least one periodic search query is performed according to a period.

20. The method according to claim 11, wherein the search request string is selected from natural language, formal language, and a combination thereof.
